(19) United States
(12) Patent Application Publication
(10) Pub. No.: US 2024/0289883 A1
(43) Pub. Date: Aug. 29, 2024

(54) METHOD AND SYSTEM FOR DETERMINING PERFORMANCE DRIFT

(71) Applicant: Wells Fargo Bank, N.A., San Francisco, CA (US)

(72) Inventors: Michael Christopher Behan, Saint Louis, MO (US); Daniel James Dial, Wildwood, MO (US); Chao Ma, Saint Louis, MO (US)

(21) Appl. No.: 17/303,384

(22) Filed: May 27, 2021

(51) Int. Cl. G06Q 40/06; G06Q 10/06

(52) U.S. Cl. CPC G06Q 40/06; G06Q 10/06393

(57) ABSTRACT

Various examples described herein are directed to systems and methods for determining a drift between an account managed by an entity and a benchmark. A time period for which the drift will be calculated is assigned and a first category having a first metric is selected. The first metric is calculated and compared to a benchmark drift profile where a score is assigned to the first metric based on the comparison. A determination is then made that a second metric for a second category having a second metric is needed to calculate the drift. The calculating, the comparing, and the assigning operations are repeated for the second metric, such that a second score is assigned for the second metric. The drift is then calculated based on the first score for the first metric and the second score for the second metric.

### BACKGROUND

A financial advisor may be responsible for handling the portfolio of a client where the client relies on the financial advisor to achieve the best results for their portfolio. For example, the client relies on the financial advisor to achieve the best rate of return on the investments held by the client in the portfolio. Typically, in order to determine whether or not the financial advisor is achieving a good rate of return on the portfolio, a client can only generically see how their portfolio has performed against certain well known benchmarks. For example, the client can compare the rate of return for their portfolio against various stock market indices, such as the NASDAQ Composite, the Dow Jones Industrial Average™, or the S&P 500™, which indices may, or may not, be an appropriate benchmark for a specific investment strategy. Nevertheless, comparing rate of the return for a portfolio against any indices, such as those mentioned above, only provides a partial picture of the performance of the portfolio. The use of rate of the return of a portfolio is limited in its explanatory power of the performance of a portfolio. A more robust approach is to evaluate the performance of a portfolio on a risk-adjusted basis. In addition, while a portfolio may be performing well when compared to specific indices, a client does not have a means of determining the actual investment performance of their financial advisor for all portfolios managed by the financial advisor.

Accordingly, what is needed is a machine that can assess the performance of both individual portfolios against a benchmark and a financial advisor by evaluating the aggregation of various individual portfolios managed by a financial advisor.

### SUMMARY

Embodiments of the present disclosure relate to assessing both the performance of a financial advisor for an individual portfolio by comparing an output of the financial advisor against a benchmark spanning time periods and the aggregate performance of a financial advisor for various independent portfolios managed by the financial advisor spanning time periods. In an embodiment, the time period (of multiple time periods) comprises a first time segment and a second time segment, or may be any other count of time segments. In an embodiment, first metrics for a plurality of categories are calculated for the first time segment for an individual portfolio. Each of the first metrics are compared to a benchmark and a first score is assigned to each of the metrics for the first time segment using the comparison. Using the first score for each of the metrics, a first performance rating is generated for the first time segment for an individual portfolio. In an embodiment, second metrics for a plurality of categories are calculated for the second time segment for an individual portfolio. Each of the second metrics are compared to the benchmark and a second score is assigned to each of the metrics for the second time segment using the comparison. Using the second score for each of the metrics, a second performance rating is generated for a second time segment for an individual portfolio. In an embodiment, the first performance rating for the first time segment is compared with the second performance rating of the second time segment and an overall performance rating is generated for the time period based on the comparison between the first performance rating and the second performance rating. In accordance with embodiments of the present disclosure, the performance rating can characterize a drift between the performance of the individual in comparison with a benchmark. For example, in embodiments where performance is being measured for a sole portfolio managed by a financial advisor, drift can refer to the difference between the performance of a portfolio based on an investment strategy and assets being managed by the financial advisor and a benchmark associated with the investment strategy and assets in the portfolio. Moreover, in embodiments where performance is being measured for multiple independent portfolios managed by a financial advisor, drift can refer to the difference between the aggregate performance of independent portfolios relative to associated benchmarks for segments of time periods.

### BRIEF DESCRIPTION OF THE DRAWINGS

FIG. 1 shows an environment in which embodiments of the present disclosure may operate.

FIGS. 2A and 2B illustrate a method for calculating a performance drift in accordance with an embodiment of the present disclosure.

FIG. 3 illustrates a matrix of a category, a metric, and a weight, where the categories can include Risk-Adjusted Returns, Return Capture, Benchmark Tracking, and Downside Risk in accordance with an embodiment of the present disclosure.

FIG. 4 illustrates a metric performance profile based on a drift of a portfolio relative to a benchmark in accordance with an embodiment of the present disclosure.

FIG. 5 shows a performance rating profile correlating to a score for a particular time segment in accordance with an embodiment of the present disclosure.

FIG. 6 illustrates a methodology that can be used to assign a performance rating to an assigned time period based on performance ratings determined for each segment in the assigned time period in accordance with an embodiment of the present disclosure.

FIG. 7 illustrates a time segment tree showing the relationship among different time segments in accordance with an embodiment of the present disclosure.

FIG. 8 illustrates calculating a performance profile and a rating for multiple portfolios at the financial advisor level, this does not pertain to the independent calculation to determine the performance profile and rating of an individual account/portfolio.

FIG. 9 shows a time tree segment where performance ratings of consecutive time periods are used to establish a performance rating of another time segment comprising a time period that encompasses the consecutive time periods.

FIG. 10 is a block diagram illustrating a computing device hardware architecture, within which a set or sequence of instructions can be executed to cause the machine to perform examples of any one of the methodologies discussed herein, in accordance with an embodiment of the present disclosure.

FIG. 11 is a block diagram showing one example of a software architecture for a computing device, in accordance with an embodiment of the present disclosure.

### DETAILED DESCRIPTION

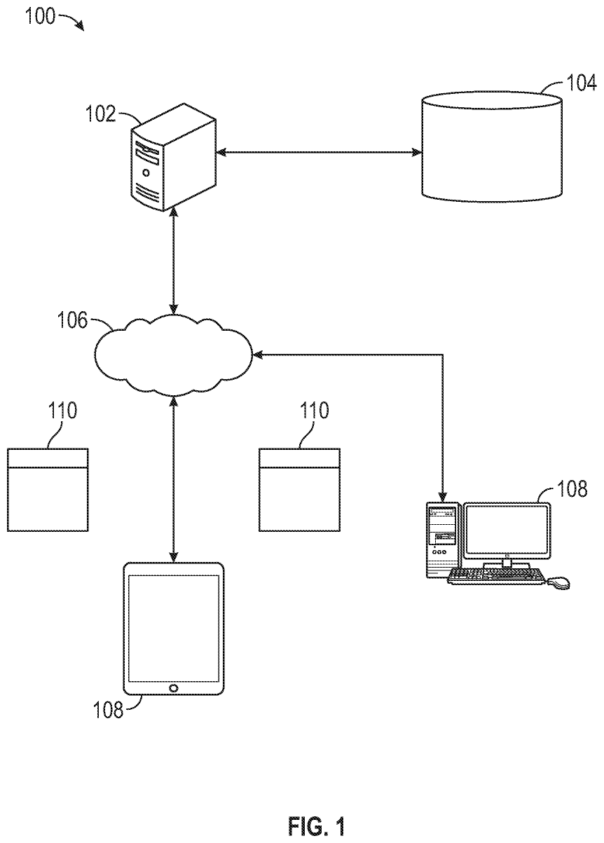

Now making reference to the Figures, and more specifically FIG. 1, an environment 100 is shown in which embodiments of the present solution may operate. The environment 100 includes a performance drift calculating computing device 102 in communication with a portfolio database 104, and a network 106. Via the network 106, the performance drift calculating computing device 102 communicates with user devices 108 and provides user interfaces (UIs) 110 for display on the user devices 108.

As will be discussed in greater detail below, the performance drift calculating computing device 102 can incorporate an architecture that facilitates operation in the capacity of either a server or a client machine in server-client network environments, where each of these devices may be implemented as any type of computing device, such as a server computer, a personal computer (PC), a distributed system, or the like, each having at least one processor configured to perform the subject matter disclosed herein. The portfolio database 104 may be any data storage resource and may store data structured as a text file, a table, a spreadsheet, a relational database (e.g., an object-relational database), a triple store, a hierarchical data store, or any suitable combination thereof.

The network 106 may be any network that enables communication between or among machines, databases, and devices (e.g., the computing device 102 and the user devices 108). Accordingly, the network 106 may be a wired network, a wireless network (e.g., a mobile or cellular network), or any suitable combination thereof. The network 106 may include one or more portions that constitute a private network, a public network (e.g., the Internet), or any suitable combination thereof. Accordingly, the network 106 may include one or more portions that incorporate a local area network (LAN), a wide area network (WAN), the Internet, a mobile telephone network (e.g., a cellular network), a wired telephone network (e.g., a plain old telephone system (POTS) network), a wireless data network (e.g., WiFi network or WiMax network), or any suitable combination thereof. Any one or more portions of the network 106 may communicate information via a transmission medium. As used herein, “transmission medium” shall be taken to include any intangible medium that is capable of storing, encoding, or carrying instructions for execution by a machine, and includes digital or analog communication signals or other intangible media to facilitate communication of such software.

The user devices 108 may be any computing device suitable for use by a user. For example, the user devices may be a desktop computer, a tablet computer, a portable media device, or a smart phone belonging to a user. The UIs 110 may be a graphical user interface that allows a user to directly interact with electronic devices, such as the user devices 108, through graphical elements, such as icons, and/or audio indicators, where the actions in the UIs 110 are performed through direct manipulation of the graphical elements. In addition, the UIs 110 are capable of displaying information received from the performance drift calculating computing device 102 on the user device 108.

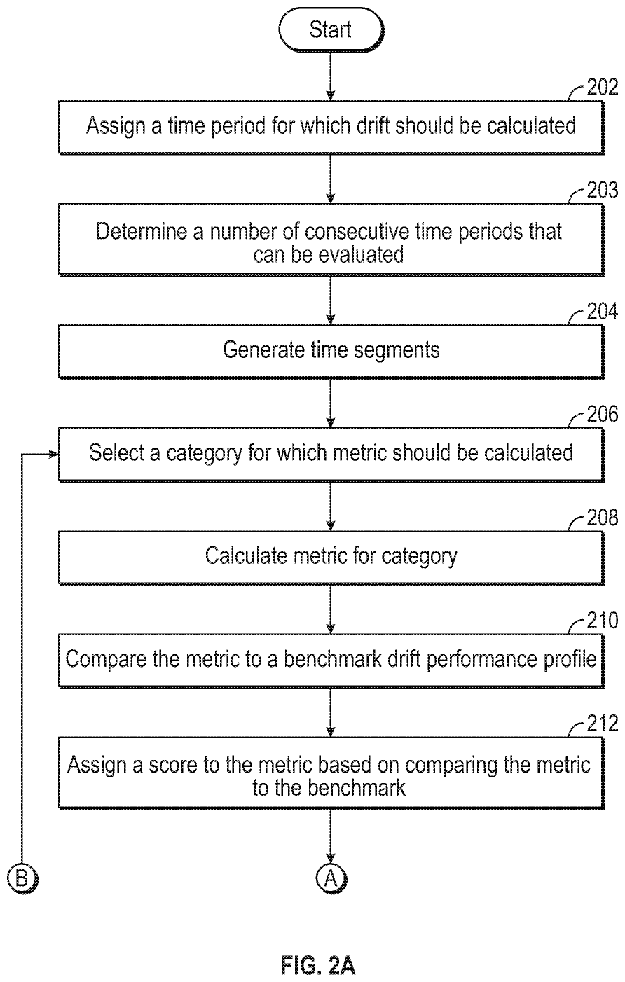

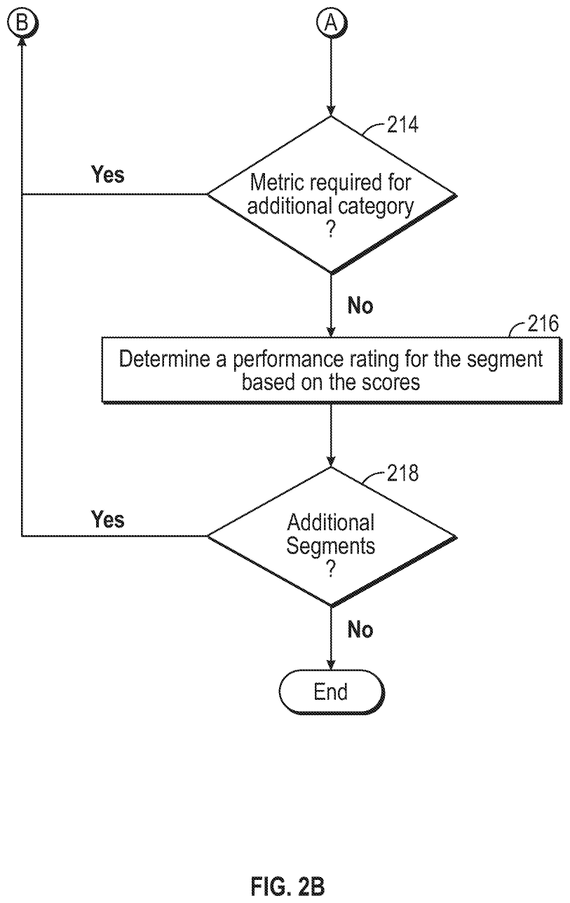

In accordance with embodiments of the present disclosure, the computing device 102 calculates a performance drift for one or more segments of time. In accordance with embodiments of the present disclosure, performance drift can refer to the difference between the performance of an entity in comparison with a benchmark. Examples of an entity can include an individual portfolio, a financial advisor, an individual metric or the like. For example, in embodiments where performance is being measured for a financial advisor, drift can refer to the difference between the performance of a portfolio (or a group of various independent portfolios under the portfolio management of the financial advisor) having assets being managed by the financial advisor and a benchmark associated with the investment strategy of assets in the portfolio. To further illustrate, if a benchmark for assets within the portfolio has seen an increase in value of 10% over a one-year period while a portfolio being managed by a financial advisor having similar assets, and potentially including non-similar assets has seen an increase in value of 8%, the drift would be negative 2%, which is the difference between 10% and 8%. Similarly, if a benchmark for the portfolio investment strategy within the portfolio has seen an increase in value of 10% over a one-year period while a portfolio being managed by a financial advisor having similar assets and potentially including non-similar assets has seen an increase in value of 15%, the drift would be 5%, which is the difference between 15% and 10%. As will be detailed further below, the drift value and its specified operation may be used to characterize the performance of the financial advisor on an individual portfolio (account) or an aggregate of various independent portfolios (accounts). An example of this is described in further detail with reference to FIGS. 2A and 2B.

FIGS. 2A and 2B illustrate a method 200 for calculating a performance drift for segments of time in accordance with an embodiment of the present disclosure. Initially, in an operation 202, a time period within which a drift should be calculated is assigned. In some embodiments, the time period can be one year or the time period can be three years. However, in accordance with embodiments of the present disclosure, any time period can be assigned. Furthermore, in an embodiment, when a time period such as one year or three years is selected, the time periods are generated in an operation 204. To further illustrate, if a time period of one year is selected, multiple time segments are generated for the time period. To further illustrate, for a nine month period, a twelve month period would be evaluated for each month in the nine month period. For example, for a time period of 2020, for the month of June 2020, the period starting on Jul. 1, 2019 to Jun. 30, 2020 would be evaluated. This methodology could be used for the additional nine months, for example looking backwards, from June 2020 to October 2019.

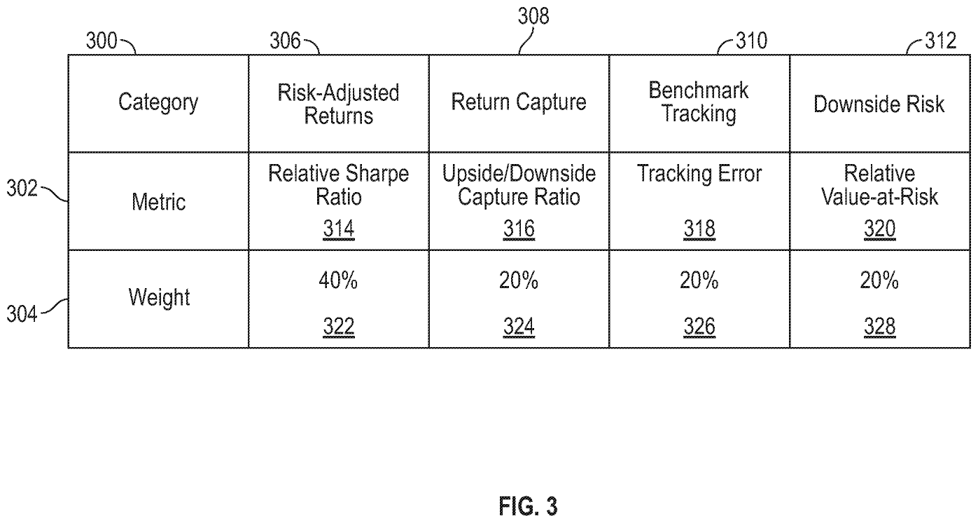

Once the time period is assigned in the operation 202, a number of consecutive time periods that can be evaluated is determined in an operation 203. For example, if a time period of one year period is determined, a number of time periods that can be evaluated to be selected can be three quarters. In an operation 204, a number of time segments are generated in the operation 204 based on the number of consecutive time periods that are determined in the operation 203. Thus, in the operation 203, if a number of time periods is three quarters, the number of time segments can be nine in the operation 204, where the segments are based on three months being in each quarter. A category for which a metric should be calculated is selected in an operation 206. In accordance with embodiments of the present disclosure, any category along with any metric can be selected. To further illustrate, making reference to FIG. 3, a matrix of a category 300, a metric 302, and a weight 304 is shown. The categories can include Risk-Adjusted Returns 306, Return Capture 308, Benchmark Tracking 310, and Downside Risk 312. Furthermore, the categories can include a Treynor Ratio, Jensen's Alpha, or any other type of indicator. In an embodiment, the metric 302 can include a Relative Sharpe Ratio 314, an Upside/Downside Capture Ratio 316, a Tracking Error metric 318, and a Relative Value-At-Risk metric 320 or any type of risk/return metric known to those skilled in the art.

After a category is selected for which a metric should be calculated, a metric corresponding to the category is calculated in an operation 208. To further illustrate the concepts of the operations 202-206, reference will be made to an example where performance drift is being calculated for a portfolio managed by a financial advisor. In the example, during the operation 202, a time period of one year is determined and the number of time periods to be evaluated is selected as being three quarters for the time period during which the drift should be calculated in the operation 202. In the operation 206, the Risk-Adjusted Returns metric 306 is selected as the category for which the metric should calculated. As shown with reference to FIG. 3, the metric that corresponds to the Risk-Adjusted Returns metric 306 can be the Relative Sharpe Ratio 314. In an embodiment, the metric is calculated for the portfolio managed by the financial advisor where a Sharpe ratio calculated for the portfolio managed by the financial advisor is compared with a Sharpe ratio for a benchmark of the investment strategy (and assets) within the portfolio managed by the financial advisor. In an embodiment, the Sharpe ratio may be calculated according to the following:

$$Sharpe Ratio = \frac{Rp - Rf}{σ p}$$

In the above, Rp is the return on the portfolio managed by the financial advisor, Rf is the risk free rate, moreover, op can relate to a volatility of the portfolio.

In an embodiment, the risk free rate can be a rate that can be achieved with an instrument that has a very low risk, such as a treasury security or the like. In an embodiment, in the operation 208, the Sharpe ratio is calculated for both the portfolio managed by the financial advisor and the benchmark, which can be used to determine the performance drift. In the operation 208, a difference between the Sharpe ratio for the portfolio managed by the financial advisor and the Sharpe ratio for the benchmark, where the Sharpe ratio for the benchmark is subtracted from the Sharpe ratio for the portfolio managed by the financial advisor, correlates to the performance drift between the portfolio managed by the financial advisor and the benchmark. In the example, the performance drift calculating computing device 102 calculates the Sharpe ratio for the portfolio managed by the financial advisor as 0.9. Moreover, the performance drift calculating computing device 102 calculates the Sharpe ratio for the benchmark as 1.0. Therefore, in this example, the metric, which is the Relative Sharpe Ratio 314, is calculated by subtracting the Sharpe ratio for the benchmark, which is 1.0, from the Sharpe ratio for the portfolio managed by the financial advisor, which is 0.9. Thus, in this example, the Relative Sharpe Ratio 314 is −0.1.

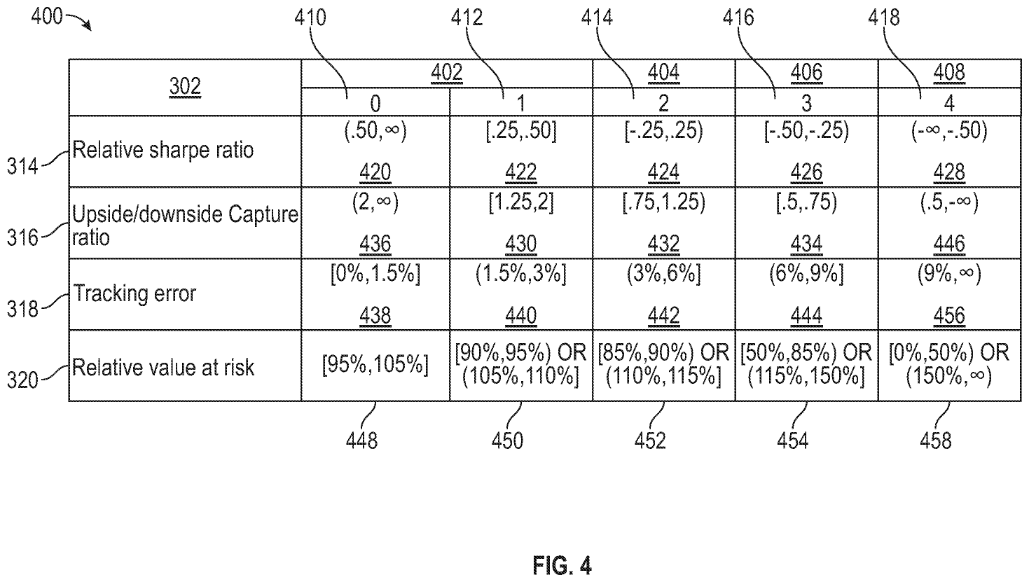

Returning to the method 200, after the metric is calculated in the operation 208, the metric is compared to a performance rating profile in an operation 210 and assigned a score based on the comparison to the benchmark in an operation 212. Returning to the example, in the operation 210, the metric, which is the Relative Sharpe Ratio 314, is compared to a benchmark drift performance profile, such as a benchmark drift performance profile 400 shown with reference to FIG. 4. In an embodiment, the performance drift calculating computing device 102 can retrieve the benchmark drift performance profile 400 from the database 104. In some embodiments, the benchmark drift performance profile 400 can be stored on a database on the performance drift calculating computing device 102. As may be seen with reference to FIG. 4, the benchmark drift metric performance profile 400 can include performance categories 402-408 each associated with a performance risk score 410-418. In an embodiment, the performance risk scores 410-418 are determined by comparing the metric calculated in the operation 208 with values 420-458. The performance risk scores 410-418 are based on a spectrum such that 410 is the lowest risk and 418 is the highest risk.

In an embodiment, the performance risk scores 410-418 are used to characterize the level of performance risk for a metric in one of the performance categories 402-408. In an embodiment, when the metric has the performance risk score 410 or 412, the metric can be characterized as having a very good drift, and thus lower risk relative to a benchmark, and will be assigned to the performance category 402. In particular, very good drift can relate to when the portfolio managed by the financial advisor outperforms the benchmark. Drift can refer to the difference between the performance of a portfolio having assets being managed by the financial advisor and a benchmark associated with the investment strategy of and assets in the portfolio. For example, using the Relative Sharpe Ratio, when the metric has the performance rating 402, the benchmark Sharpe Ratio may have a value of 0.30 while the portfolio Sharpe Ratio may have a value of 1.0 for a drift differential of 0.70. It should be noted that the values are given for demonstrative purposes only and embodiments herein should not be constrained to these values. Embodiments disclosed herein envision other values and other ranges of values. Thus, the metric associated with the portfolio managed by the financial advisor is outperforming the benchmark. Moreover, as shown with reference to FIG. 4, the scores 410 and 412 each have a numerical value associated therewith. Here, the score 410 has a numerical risk value of “0” and the score 412 has a numerical risk value of “1.” It should be noted that in accordance with embodiments of the present disclosure, the scores 410 and 412 may be assigned any numerical value.

In an embodiment, when the metric has the score 414, the metric can be characterized as having a good drift and will be assigned to the performance category 404. In particular, good drift can relate to when the portfolio managed by the financial advisor performs reasonable relative to the benchmark. To further illustrate using the Relative Sharpe Ratio, the benchmark may have a Sharpe Ratio of 0.30 while the portfolio Sharpe metric may have value 0.40 for a drift differential of 0.10. In this scenario, the metric associated with the portfolio managed by the financial advisor is reasonably performing relative to the benchmark. In some embodiments, the reasonable performance can be slightly outperforming or slightly underperforming based on the numeric Sharpe. However, this performance is not as good as a performance associated with the performance category 402. It should be noted that the values are given for demonstrative purposes and embodiments herein should not be constrained to these values. Thus, embodiments disclosed herein envision other values and other ranges of values. Here, the score 414 has a numerical value of “2.” It should be noted that in accordance with embodiments of the present disclosure, the score 414 may be assigned any numerical value.

In an embodiment, when the metric has the score 416, the metric can be characterized as drifting from the metric associated with the benchmark such that the portfolio managed by the financial advisor is not performing as well as the benchmark. To further illustrate using the Relative Sharpe Ratio, the benchmark may have a Sharp Ratio of 0.40 while the portfolio Sharpe Ratio metric may have value 0.10 for a drift differential of −0.30. In this scenario, the metric associated with the portfolio managed by the financial advisor has drifted from the benchmark in a direction that detracts from a similar risk-adjusted return trajectory. It should be noted that the values are given for demonstrative purposes and embodiments herein should not be constrained to these values. Thus, embodiments disclosed herein envision other values and other ranges of values. Here, the score 416 has a numerical risk value of “3.” It should be noted that in accordance with embodiments of the present disclosure, the score 416 may be assigned any numerical value.

Moreover, when the metric has the score 418, the metric can have the performance rating 408 and can be characterized as drifting further from the metric associated with the benchmark such that the portfolio managed by the financial advisor is meaningfully underperforming, not performing as well as, the benchmark. When the metric has the score 418, the portfolio managed by the financial advisor is performing worse than when the portfolio managed by the financial advisor has the score 416. To further illustrate, using the Relative Sharpe Ratio, the benchmark may have a Sharpe Ratio of 0.80 while the portfolio Sharpe Ratio metric may have a value of 0.20 for a drift differential of −0.60. In this scenario, the metric associated with the portfolio managed by the financial advisor has drifted from the benchmark more than when the metric has the performance rating 406. It should be noted that the values are given for demonstrative purposes and embodiments herein should not be constrained to these values. Thus, embodiments disclosed herein envision other values and other ranges of values. Here, the score 418 has a numerical risk value of “4.” It should be noted that in accordance with embodiments of the present disclosure, the score 418 may be assigned any numerical value.

In an example, the Relative Sharpe Ratio 314 is −0.1. In order to assign a score where the Relative Sharpe Ratio 314 is −0.1, the value −0.1 is compared with the values 420-428. In an embodiment, the value 420 has a range of (0.50, ∞). Thus, in order to have the score 410, the Relative Sharpe Ratio 314 should be greater than 0.50. In the example, when the Relative Sharpe Ratio 314 is compared to the value 420 in the operation 210, a determination is made that the Relative Sharpe Ratio 314 does not fall into this range. Accordingly, the Relative Sharpe Ratio 314 does not have the score 410.

In an embodiment, the value 422 has a range of [0.25, 0.50]. Thus, in order to have the score 412, the Relative Sharpe Ratio 314 should be in the range of equal to or greater than 0.25 and equal to or less than 0.50. In the example, when the Relative Sharpe Ratio 314 is compared to the value 422 in the operation 210, a determination is made that the Relative Sharpe Ratio 314 does not fall into this range. As noted above, in the example, the Relative Sharpe Ratio 314 is −0.1 and does not fall into this range. Thus, the Relative Sharpe Ratio 314 does not have the score 412.

In an embodiment, the value 424 has a range of [−0.25, 0.25). Thus, in order to have the score 414, the Relative Sharpe Ratio 314 should be in the range of equal to or great than −0.25 and less than 0.25. In the example, when the Relative Sharpe Ratio 314 is compared to the value 424 in the operation 210, a determination is made that the Relative Sharpe Ratio 314 does fall into this range. In the example, the Relative Sharpe Ratio 314 has a score of −0.1 and therefore falls into the range of [−0.25 to 0.25). Accordingly, the Relative Sharpe Ratio 314 is assigned the score 414 in the operation 212.

As shown with reference to FIG. 4 and mentioned above, the benchmark drift performance profile 400 includes the values 426 and 428, which correspond to the scores 416 and 418 and the performance ratings 406 and 408. In order to have the score 426, in this example, the Relative Sharpe Ratio 314 would have to fall within the range of [−0.50 and −0.25). Moreover, in order to have the score 428, in this example, the Relative Sharpe Ratio 314 would have to be in range (−0.50 and −∞) which means having a value less than −0.50. It should be noted that the ranges given for the values 420-428 are given for demonstrative purposes and embodiments herein should not be constrained to these values. Thus, embodiments disclosed herein envision other values and other ranges of values.

Returning attention to the method 200, after the score is assigned to the metric in the operation 212, a determination is made if a metric is required for an additional category in an operation 214, as shown with reference to FIG. 2B. If a determination is made that a metric is required for an additional category, the operations 204-208 are repeated. Otherwise, an operation 216 is performed.

In an embodiment, in order to determine the drift between a portfolio managed by the financial advisor and a benchmark, multifactor verification can be used. In an embodiment, each of the factors in the multifactor verification can relate to the metric 302. Thus, each of the factors can correspond to the Relative Sharpe Ratio 314, the Upside/Downside Capture Ratio 316, the Tracking Error metric 318, and the Relative Value-At-Risk metric 320. In an embodiment where the multifactor verification is a four factor verification, the four factors can correspond to the Relative Sharpe Ratio 314, the Upside/Downside Capture Ratio 316, the Tracking Error metric 318, and the Relative Value-At-Risk metric 320. In accordance with further embodiments of the present disclosure, the multifactor verification can be less than a four factor verification. Here, the factors may be any combination of the Relative Sharpe Ratio 314, the Upside/Downside Capture Ratio 316, the Tracking Error metric 318, and the Relative Value-At-Risk metric 320. To further illustrate, if the multifactor verification is a three factor verification, the metrics corresponding to the factors can be any combination of three of the Relative Sharpe Ratio 314, the Upside/Downside Capture Ratio 316, the Tracking Error metric 318, and the Relative Value-At-Risk metric 320. Also, in an embodiment, if the multifactor verification is a two factor verification, the metrics corresponding to the factors can be any combination of two of the Relative Sharpe Ratio 314, the Upside/Downside Capture Ratio 316, the Tracking Error metric 318, and the Relative Value-At-Risk metric 320. Moreover, the multifactor verification can be a five factor verification where one additional metric, such as the Treynor Ratio or Jensen's Alpha, can be included. Furthermore, the multifactor verification can be a six factor verification where two additional metrics, such as the Treynor Ratio and Jensen's Alpha, can be included.

In the example, four factor verification is being used to calculate the drift between the portfolio managed by the financial advisor and the benchmark. In the example, only the Relative Sharpe Ratio 314 has been verified. Therefore, in the operation 214, the method 200 determines that a metric is required for an additional category and the operations 204-210 are repeated. In the operation 206, the Return Capture metric 308 is selected as the category for which the metric should calculated. As shown with reference to FIG. 3, the metric that corresponds to the Return Capture metric 308 can be the Upside/Downside Capture Ratio 316. In an embodiment, the Upside/Downside Capture Ratio 316 is a combination of the independent Upside Capture Ratio and the Downside Capture Ratio. In an embodiment, the Upside Capture Ratio may be defined according to the following:

$$Upside Capture Ratio = 100 * ( \frac{Portfolio Return During Bull Run}{Benchmark Return During Bull Run} )$$

The Upside Capture Ratio can be based on cumulative returns during defined units of time and when the benchmark return is positive during the defined units of time. During the same time periods in which the benchmark return is positive, the portfolio return is evaluated for comparison. In the above, “Portfolio Return During Bull Run” equals the return of the portfolio managed by the financial advisor during each a time period where there is a rise in the market. Moreover, “Benchmark Return During Bull Run” equals the return of the benchmark during the same time periods

In an embodiment, the Downside Capture Ratio may be defined according to the following:

$$Downside Capture Ratio = 100 * ( \frac{Portfolio Return During Bear Run}{Benchmark Return During Bear Run} )$$

The Downside Capture Ratio can be based on returns during defined units of time and when the benchmark return is negative during the defined units of time. During the same time periods in which the benchmark return is negative, the portfolio return is evaluated for comparison. In the above, “Portfolio Return During Bear Run” equals the return of the portfolio managed by the financial advisor during a bear run, such as time periods during which the market dips from a previous peak of the market. Moreover, “Benchmark Return During Bear Run” equals the return of the benchmark during the same time periods.

In an embodiment, the Upside/Downside Capture Ratio 316 may be defined according to the following:

$$Upside / Downside Capture Ratio = ( \frac{Upside Capture Ratio}{D o w nside Capture Ratio} )$$

In the example, during the time period assigned in the operation 202, the benchmark experienced periods of both positive returns and negative returns. Using the Equation above for the upside capture ratio, the performance drift calculating computing device 102 calculates an upside capture ratio of 60. In particular, during the periods when the benchmark had positive returns, the benchmark increased by 10% while the portfolio managed by the financial advisor during these same time periods increased by 6%. Thus, the value increase of the portfolio managed by the financial advisor was 60% of the benchmark increase. Moreover, the performance drift calculating computing device 102 calculates a downside capture ratio of 33. In particular, during the periods when the benchmark had negative returns, the benchmark decreased by 6% while the portfolio managed by the financial advisor decreased by 2% during these same time periods. As such, the value decrease of the portfolio managed by the financial advisor was 33% of the benchmark decrease. In this example, the performance drift calculating computing device 102 calculates the Upside/Downside Capture Ratio 316 as 1.82 in the operation 208 by taking 60%/33% (upside capture ratio/downside capture ratio).

In the example, the performance drift calculating computing device 102 performs the operation 210 with the Upside/Downside Capture Ratio 316 by comparing the Upside/Downside Capture Ratio 316 with the benchmark drift metric performance profile 400. In order to assign the score for the Upside/Downside Capture Ratio 316 having a value of 1.82, the performance drift calculating computing device 102 compares the value 1.82 with the values 430-436 and 446. In an embodiment, the value 436 has a range of (2, ∞). Thus, in order to have the score 410, the Upside/Downside Capture Ratio 316 should be greater than 2. In the example, when the Upside/Downside Capture Ratio 316 is compared to the value 436 in the operation 210, a determination is made that the Upside/Downside Capture Ratio 316 does not fall into this range. Accordingly, the Upside/Downside Capture Ratio 316 does not have the score 410. In an embodiment, the value 430 has a range of [1.25, 2]. Thus, in order to have the score 412, the Upside/Downside Capture Ratio 316 should be in the range of equal to or greater than 1.25 and equal to or less than 2. In the example, when the Upside/Downside Capture Ratio 316 is compared to the value 430 in the operation 210 by the performance drift calculating computing device 102, a determination is made that the Upside/Downside Capture Ratio 316 falls into this range. As noted above, in the example, the Upside/Downside Capture Ratio 316 is 1.82 and therefore falls into the range associated with the value 430. Thus, the Upside/Downside Capture Ratio 316 is assigned the score 412 in the operation 212.

Still making reference to FIG. 4 and the benchmark drift performance profile 400, as shown, the value 432 has a range of [0.75, 1.25). Thus, in order to have the score 414, the Upside/Downside Capture Ratio 316 should be in the range of equal to or greater than 0.75 and less than 1.25. Moreover, as shown with reference to FIG. 4 and mentioned above, the benchmark drift performance profile 400 includes the values 434 and 446, which correspond to the scores 416 and 418. In order to have the score 434, in this example, the Upside/Downside Capture Ratio 316 would have to fall within the range of [0.50 and 0.75). Moreover, in order to have the score 418, in this example, the Upside/Downside Capture Ratio 316 would have to be less than 0.50. It should be noted that the ranges listed for the values 430-436 and 446 are given for demonstrative purposes and embodiments herein should not be constrained to these values. Thus, embodiments disclosed herein envision other values and other ranges of values.

Once the performance drift calculating computing device 102 completes the operation 212, the operation 214 is repeated. In the example, four factor verification is being used to calculate the drift between the portfolio managed by the financial advisor and the benchmark. In the example, only the Relative Sharpe Ratio 314 and the Upside/Downside Capture Ratio 316 have been verified. Therefore, in the operation 214, the method 200 determines that a metric is required for an additional category and the operations 204-210 are repeated. In the operation 206, the Benchmark Tracking category 310 is selected as the category for which the metric should calculated. As shown with reference to FIG. 3, the metric that corresponds to the Benchmark Tracking category 310 can be the Tracking Error metric 318. In an embodiment, the Tracking Error metric 318 can be the standard deviation of the difference of the return of the portfolio managed by the financial advisor and the return of the benchmark over a given period of time. Thus, the Tracking Error metric 318 tracks how the portfolio managed by the financial advisor is tracking the benchmark. In an embodiment, the greater the tracking error, the greater the risk associated with the portfolio managed by the financial advisor relative to the associated benchmark. Thus, in some embodiments, a higher tracking error metric can correspond to the return for the portfolio managed by the financial advisor being higher than the return for the benchmark. Conversely, in some embodiments, a higher tracking error metric can correspond to the return for the portfolio managed by the financial advisor being lower than the return for the benchmark. Moreover, in an embodiment, a low tracking error can mean that the returns of the portfolio managed by the financial advisor is tracking closely to the return of the benchmark over time.

In an embodiment, the Tracking Error metric 318 can be calculated by determining the standard deviation of the difference in returns of the portfolio managed by the financial advisor and the return of the benchmark using any methodology, such as the historical method, the Monte Carlo method, or the like. In an embodiment, the Tracking Error metric 318 can be independent of the relative Sharpe Ratio metric 314 and the Upside/Downside Capture Ratio 316. In the example, the performance drift calculating computing device 102 computes the return on the standard deviation of the difference in monthly returns of the portfolio managed by the financial advisor relative to the benchmark over the one year period of time as 3.5% in the operation 208. Therefore, in some embodiments, if the return of the benchmark is 10%, the return of the portfolio managed by the financial advisor can be 13.5%. Conversely, if the return of the benchmark is 10%, the return of the portfolio managed by the financial advisor can be 6.5%.

In the operation 210, the performance drift calculating computing device 102 compares the Tracking Error metric 318 with the benchmark drift performance profile 400. In order to assign a score to the Tracking Error metric 318 having a value of 3.5%, the performance drift calculating computing device 102 compares the value 3.5% with the values 438-444 and 456. In an embodiment, the value 438 has a range of [0%, 1.5%]. Thus, in order to have the score 410, the Tracking Error metric 318 should be equal to or greater than 0% and equal to or less than 1.5%. In the example, when the Tracking Error metric 318 is compared to the value 438 in the operation 210, a determination is made that the Tracking Error metric 318 does not fall into this range. Accordingly, the Tracking Error metric 318 does not have the score 410.

In an embodiment, the value 440 has a range of (1.5%, 3%]. Thus, in order to have the score 412, the Tracking Error metric 318 should be in the range of greater than 1.5% and equal to or less than 3%. In the example, when the Tracking Error metric 318 is compared to the value 440 in the operation 210 by the performance drift calculating computing device 102, a determination is made that the Tracking Error metric 318 does not falls into this range. Thus, the Tracking Error metric 318 does not have the score 412.

Still making reference to FIG. 4 and the benchmark drift performance profile 400, as shown, the value 442 has a range of (3%, 6%]. Thus, in order to have the score 414, the Tracking Error metric 318 should be in the range of greater than 3% and equal to or less than 6%. As noted above, the Tracking Error metric 318 has a value of 3.5%. As such, the Tracking Error metric 318 falls within the range associated with the value 442 and the performance drift calculating computing device 102 assigns the score 414 to the Tracking Error metric 318 in the operation 212.

Moreover, as shown with reference to FIG. 4, the benchmark drift performance profile 400 includes the values 444 and 456, which correspond to the scores 416 and 418. In order to have the score 416, in this example, the Tracking Error metric 318 would have to fall within the range of (6%, 9%]. Moreover, in order to have the score 418, in this example, the Tracking Error metric 318 would have to be greater than 9%. It should be noted that the ranges listed for the values 438-444 and 456 are given for demonstrative purposes and embodiments herein should not be constrained to these values. Thus, embodiments disclosed herein envision other values and other ranges of values.

Once the performance drift calculating computing device 102 completes the operation 212 for the Tracking Error metric 318, the operation 214 is repeated. In the example, four factor verification is being used to calculate the drift between the portfolio managed by the financial advisor and the benchmark. In the example, the Relative Sharpe Ratio 314, the Upside/Downside Capture Ratio 316, and the Tracking Error metric 318 have been verified. Therefore, in the operation 214, the method 200 determines that a metric is required for an additional category and the operations 204-210 are repeated. In the operation 206, the Downside Risk category 312 is selected as the category for which the metric should be calculated.

As shown with reference to FIG. 3, the metric that corresponds to the Downside Risk category 312 can be the Relative Value-At-Risk metric 320. As those skilled in the art can appreciate, a Value-At-Risk metric can be a metric that estimates the downside risk associated with a portfolio. The Value-At-Risk metric can be a metric that provides the probability of a portfolio losing more than a certain amount over a specified period of time. In an embodiment, the performance drift calculating computing device 102 can calculate the Value-At-Risk metric using a variety of techniques known to those skilled in the art, such as the historical method, the parametric method, the Monte Carlo method, or the like. In particular, using any one of these methodologies, the performance drift calculating computing device 102 can calculate the Value-At-Risk for the portfolio managed by the financial advisor and independently calculate the Value-At-Risk for the benchmark and then take the ratio of the Value-At-Risk of the portfolio divided by the Value-At-Risk of the benchmark to determine the Relative Value-At-Risk. In an embodiment, the ratio of the Value-At-Risk for the portfolio managed by the financial advisor and the Value-At-Risk for the benchmark can be referred to as the Relative Value-At-Risk metric 320. In the example, in the operation 208, the performance drift calculating computing device 102 calculates the Value-At-Risk over a one calendar year period of time for the portfolio managed by the financial advisor as being −20%. Moreover, the performance drift calculating computing device 102 calculates the Value-At-Risk for the benchmark as being −10%. Therefore, in this example, based on the −10% and the −20% values, in the operation 208, the performance drift calculating computing device 102 calculates the Relative Value-At-Risk metric 320 as 200% in the operation 208.

In the operation 210, the performance drift calculating computing device 102 compares the Relative Value-At-Risk metric 320 with the benchmark drift performance profile 400 in the operation 210 in order to assign a score to the Relative Value-At-Risk metric 320 in the operation 212. In order to assign a score to the Relative Value-At-Risk metric 320 having a value of 200%, the performance drift calculating computing device 102 compares the value of 200% with the values 448-454 and 458. In an embodiment, the value 448 has a range of [95%, 105%]. Thus, in order to have the score 410, the Relative Value-At-Risk metric 320 should be have a ratio equal to or greater than 95% and equal to or less than 105% of the portfolio Value-At-Risk relative to the benchmark Value-At-Risk. In the example, since the Relative Value-At-Risk metric 320 has a value of 200%, the Relative Value-At-Risk metric 320 does not fall within the range associated with the value of 448.

In an embodiment, the value 450 has a range of [90%, 95%) or (105%, 110%]. Thus, in order to have the score 412, the value of the Relative Value-At-Risk metric 320 should have a ratio in a range that is equal to or greater than 90% and less than 95% or range that is greater than 105% and equal to or less than 110%. In the example, since the Relative Value-At-Risk metric 320 has a ratio of 200%, the Relative Value-At-Risk metric 320 does not fall within the range associated with the value of 450.

In an embodiment, the value 452 has a range of [85%, 90%) or (110%, 115%]. Thus, in order to have the score 414, the value of the Relative Value-At-Risk metric 320 should have a ratio in a range that is equal to or greater than 85% and less than 90% or range that is greater than 110% and equal to or less than 115%. In the example, since the Relative Value-At-Risk metric 320 has a ratio of 200%, the Relative Value-At-Risk metric 320 does not fall within the range associated with the value of 452.

In an embodiment, the value 454 has a range of [50%, 85%) or (115%, 150%]. Thus, in order to have the score 416, the value of the Relative Value-At-Risk metric 320 should have a ratio in a range that is equal to or greater than 50% and less than 85% or range that is greater than 115% and equal to or less than 150%. In the example, since the Relative Value-At-Risk metric 320 has a ratio of 200%, the Relative Value-At-Risk metric 320 does not fall within the range associated with the value of 454.

In an embodiment, the value 458 has a range of [0%, 50%) or (150%, ∞). Thus, in order to have the score 418, the value of the Relative Value-At-Risk metric 320 should have a ratio in a range that is equal to or greater than 0% and less than 50% or range that is greater than 150%. In the example, since the Relative Value-At-Risk metric 320 has a ratio of 200%, the Relative Value-At-Risk metric 320 is within the range associated with the value of 458. Therefore, in the operation 210 the performance drift calculating computing device 102 determines that the value for the Relative Value-At-Risk metric 320 falls within a range for the value 458. Accordingly, the performance drift calculating computing device 102 assigns the Relative Value-At-Risk metric 320 the score 418 in the operation 212.

It should be noted that the ranges listed for the values 448-454 and 458 are given for demonstrative purposes and embodiments herein should not be constrained to these values. Thus, embodiments disclosed herein envision other values and other ranges of values.

Once the performance drift calculating computing device 102 completes the operation 212 for the Relative Value-At-Risk metric 320, the operation 214 is repeated. In the example, four factor verification is being used to calculate the drift between the portfolio managed by the financial advisor and the benchmark. In the example, the Relative Sharpe Ratio 314, the Upside/Downside Capture Ratio 316, the Tracking Error metric 318, and the Relative Value-At-Risk metric 320 have been verified. Therefore, in the example, at the operation 214, the performance drift calculating computing device 102 determines that no additional metrics for additional categories require verification. It should be noted that in an embodiment, if additional metrics were required, i.e., five or six factor verifications, operations 204-210 would be repeated for metrics associated with the additional categories requiring verification. Since the method 200 determined in the operation 214 that no additional metrics for additional categories require verification, the method 200 performs the operation 216.

In the operation 216, a performance rating for the time segment based on the score is determined. In an embodiment, the performance rating can correlate to the performance drift described above such that the metric performance rating can be used to characterize the performance drift. As noted above, each of the metrics 302 were assigned a score in the operation 212. In the operation 216, the scores are used to determine a metric performance rating for the time segment of the time period assigned in the operation 202. In an embodiment, the scores assigned to each of the metrics are combined to form an overall score where each of the scores may be weighted such that an individual score may have a higher weight relative to another score. To further illustrate, making reference to FIG. 3, weights 322-328 can be assigned to each of the metrics 314-320. In particular, the weight 322 can weight the score associated with the Relative Sharpe Ratio metric 314 and the weight 324 can weight the score associated with Upside/Downside Capture Ratio metric 316. Moreover, in an embodiment, the weight 326 can weight the score associated with the Tracking Error metric 318 and the weight 328 can weight the score associated with Relative Value-At-Risk metric 320.

In an embodiment, each of the scores associated with the metrics 314-320 are adjusted based on the weight and then summed together to form a current month profile score for a particular time segment for an individual portfolio score which can be used to determine a performance rating for a time segment of the time period that corresponds to the performance drift. As shown with reference to FIG. 3, the weight 322 has a value of 40% while the weights 324-328 each have a value of 20%. Accordingly, in an embodiment, the score associated with the Relative Sharpe Ratio 314 has a weight that is 40% of the overall score while the Upside/Downside Capture Ratio metric 316, the Tracking Error metric 318, and the Relative Value-At-Risk metric 320 are each assigned a weight of 20% of the overall score. It should be noted that while 40% and 20% are shown as the relative values for each of the weights 322-328, any combination of percentages that add up to 100% can be used, such as 25% for of the weights 322-328, or the like. In an example, the overall score can be calculated according to the following:

$$Current Month Profile Time Segment Score = ( Relative Sharpe Ratio metric 314 score ) ( weight 322 ) + ( \frac{Upside}{Downside} Capture Ratio metric 316 score ) ( weight 324 ) + ( Tracking Error metric 318 score ) ( weight 326 ) + ( Relative Value - At - Risk metric 320 score ) ( weight 328 )$$

Returning to the example, as detailed above, the Relative Sharpe Ratio metric 314 was assigned the score 414 in the operation 212. Therefore, the score associated the Relative Sharpe Ratio metric 314 has a numerical value of “2,” as shown with reference to FIG. 4. The Upside/Downside Capture Ratio metric 316 is assigned the score 412 in the operation 212. Accordingly, the score associated with the Upside/Downside Capture Ratio metric 316 has a numerical value of “1,” as shown with reference to FIG. 4. Moreover, the Tracking Error metric 318 was assigned the score 414 and has a numerical value of “2.” In addition, the Relative Value-At-Risk metric 320 was assigned the score 418 in the operation 212. Therefore, the score associated the Relative Value-At-Risk metric 320 has a numerical value of “4.” Using the Current Month Profile Score Equation described with the scores for the metrics 314-320 and the weights 322-328 results in a Current Month Profile Score for the time segment for the individual portfolio of 22.

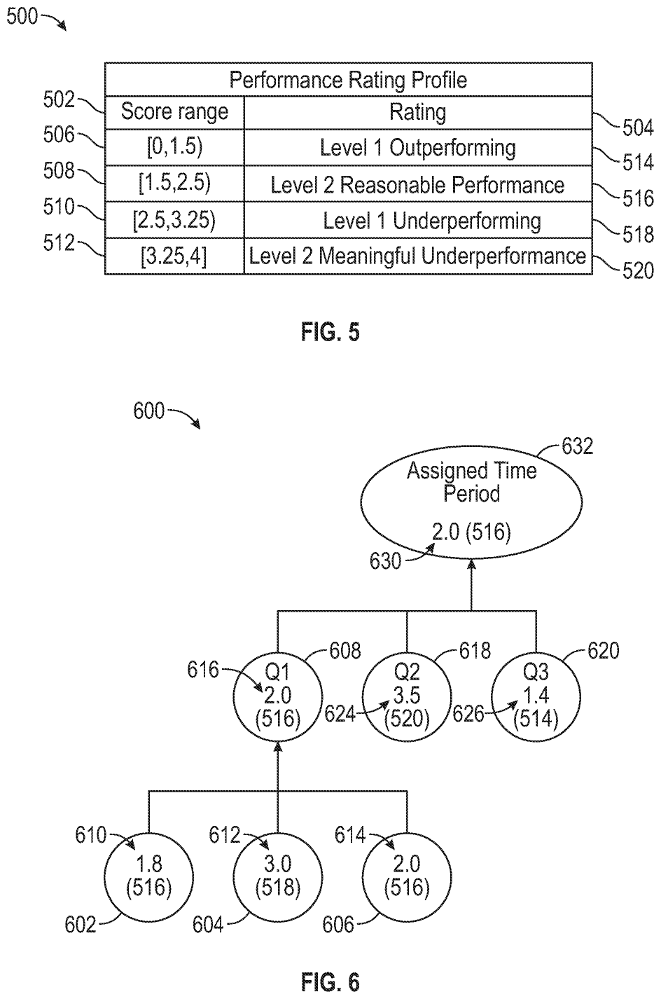

In an embodiment, the Current Month Profile Score can then be compared against a score range associated with a performance rating. In particular, making reference to FIG. 5, a performance rating profile 500 for correlating a Current Month Profile Score for an individual portfolio to a performance rating is shown in accordance with an embodiment of the present disclosure. As may be seen with reference to FIG. 5, the performance rating profile 500 can include a score range 502 and a performance rating 504 that can be associated with the score range 502. In an embodiment, the score range 502 can include score ranges 506-512 and the performance rating 504 can include performance ratings 514-520. In an embodiment, the overall score is compared to the score ranges 506-512. Based on which of the score ranges 506-512 the overall score falls into, a performance rating can be determined with the performance ratings 514-520. In particular, making reference to FIG. 5, the Performance Rating Profile can be applied to both a current month profile time segment for an individual portfolio and the current month profile time segment for multiple portfolios managed by the financial advisor.

More specifically, in an embodiment, the score range 506 includes a range [0, 1.5) and corresponds to the performance rating 514, which is a Level 1 Outperforming rating. In an embodiment, the score range 508 includes a range [1.5, 2.5) and corresponds to the performance rating 516, which is a Level 2 Performing Reasonable rating. It should be noted that FIG. 5 illustrates numerals enclosed by either brackets or parenthesis. In an embodiment, the brackets can indicate that the actual number is touched and parenthesis can indicate that the actual number is not touched but instead corresponds to a limit of a score that asymptotically reaches the number in parenthesis. As mentioned above, the performance rating corresponds to the performance drift, where the performance drift, or drift, can refer to the difference between a four factor verification methodology metrics performance of a portfolio managed by a financial advisor and a benchmark. Moreover, as noted above, the performance rating can correlate to the performance drift described above such that the performance rating can be used to characterize the collective performance drift based on the metrics in the four factor verification. The performance ratings 514-520 can be used to characterize the performance drift.

In an embodiment, the Level 1 Outperforming rating 514 indicates that the portfolio drift is outperforming the benchmark based on the four factor verification and the Level 2 Performing Reasonable rating 516 can indicate that the portfolio drift is performing reasonable relative to the benchmark based on the four factor verification. However, the relative performance drift associated with the Level 2 Performing Reasonable rating 516 may not be as great as the performance improvement drift associated with the Level 1 Outperforming rating 514. It should be noted that the values for the ratings 514 and 516 are given for demonstrative purposes and embodiments herein should not be constrained to these values. Thus, embodiments disclosed herein envision other values and other ranges of values.

Returning attention to the performance rating profile 500, the score range 510 can include a range [2.5, 3.25) and corresponds to the performance rating 518, which is a Level 1 Underperforming rating. Furthermore, the score range 512 can include a range [3.25, 4] and corresponds to the performance rating 520, which is a Level 2 Meaningful Underperformance rating. In an embodiment, the Level 1 Underperforming rating 518 and the Level 2 Meaningfully Underperforming rating 520 can each indicate that an increased risk drift exists between a return of a portfolio managed by a financial advisor and a benchmark. To further illustrate, if a benchmark for assets within the portfolio has resulted in a Sharpe Ratio of 0.50 over a one-year period while a portfolio being managed by a financial advisor having the same assets has resulted in a Sharpe Ratio of 0.10, the drift would be −0.40, which is the difference between 0.10 and 0.50 and, in an embodiment, is an increased risk drift resulting in Level 1 Underperforming rating. In an embodiment, the Level 2 Meaningfully Underperforming rating 520 can indicate that a meaningful increased risk drift exists between a return of a portfolio managed by a financial advisor and a benchmark. However, the meaningful increased risk drift associated with the Level 2 Meaningfully Underperforming rating 516 can be greater than the increased risk drift associated with the Level 1 Underperforming rating 518. To further illustrate, if a benchmark for assets within the portfolio has resulted in a Sharpe Ratio of 0.70 over a one-year period while a portfolio being managed by a financial advisor having the same assets has resulted in a Sharpe Ratio of 0.10, the drift would be −0.60, which is the difference between 0.10 and 0.70 and, in an embodiment, is a meaningfully increased risk drift resulting in Level 2 Meaningfully Underperforming. It should be noted that the values for the ratings 510 and 512 are given for demonstrative purposes and embodiments herein should not be constrained to these values. Thus, embodiments disclosed herein envision other values and other ranges of values.

In the example, the overall score was calculated as being 2.2. Thus, in the operation 216, the performance drift calculating computing device 102 compares the overall score with the score ranges 506-512 in the performance rating profile 500. In the example, the score range 508 has a range of [1.5, 2.5). The score 2.2 falls within this range. Therefore, in the operation 216, the performance drift calculating computing device 102 determines that the performance rating for the assigned time period of the financial advisor is the Level 2 Performing Reasonable rating 516. Therefore, in this example, the return of the portfolio managed by the financial advisor has a reasonably similar risk drift relative to the benchmark against which the portfolio is being compared.

Once the method 200 performs the operation 216, the method 200 performs an operation 218 where a determination is made if a performance rating should be determined for additional segments in the assigned time period. If a determination is made that a performance rating should be determined for additional segments in the assigned time period in the operation 218, then the operations 206-216 are repeated for each additional segment. Returning to the example, as noted above, a time period of one year was assigned in the operation 202 and a total of nine segments were generated in the operation 218. Therefore, eight segments still remain and the operations 202-216 will be repeated for the remaining eight segments. Once a determination is made that a performance rating does not to be determined for additional segments in the assigned time period, the method 200 is complete.

As detailed above, the method 200 determines performance ratings for each segment of the assigned time period. Based on the performance rating for each assigned time segment, an overall performance rating is determined for the assigned time period, as shown with reference to FIG. 6. FIG. 6 illustrates a methodology 600 that can be used to assign a performance rating to the assigned time period based on the performance ratings determined for each segment in accordance with an embodiment of the present disclosure. In an embodiment, in order to determine a performance rating that will be assigned to the time period, the time segments are formed into groups, where the groups form a group that corresponds to the time period assigned in the operation 202.

As discussed above, in an embodiment, the assigned time period is divided into segments. FIG. 6 illustrates time segments 602-606, which correspond to the segments of the assigned time period and include the performance ratings calculated for each time segment discussed with reference to FIGS. 2A and 2B. While only three time segments are shown, it should be noted that the following discussion is applicable to any number of time segments. As shown, the time segments 602-606 form a group, a quarterly segment 608. Here, scores 610-614 and the performance ratings of the time segments 602-606 are used to determine the performance rating of the quarterly segment 608 along with a score 616 of the quarterly segment 608.

FIG. 6 also illustrates quarterly segments 618 and 620 having scores 624 and 626. The scores 624 and 626 along with the performance ratings 514-520 of the quarterly segments 608, 618, and 620 are formed with time segments generated using the method 200, in accordance with embodiments of the present disclosure.

In an embodiment, each of the time segments 602-606 includes the scores 610-614 determined as discussed with reference to FIGS. 2A and 2B and the method 200. Here, the time segment 602 can include the score 610 while the time segment 604 can include the score 612 and the time segment 606 can include the score 614. In addition, the time segment 602 can include the performance rating 516, the time segment 604 can include the performance rating 518, and the time segment 606 can include the performance rating 516.

In an embodiment, the performance drift calculating computing device 102 determines the performance ratings and the scores 616 of the quarterly segment 608 using the performance ratings and the scores 610-614 of the time segments 602-606. In particular, the performance drift calculating computing device 102 determines which performance rating among the performance ratings of the time segments 602-606 appears with the most frequency among the time segments forming a quarterly segment. To further illustrate, as shown with reference to FIG. 6, the time segments 602 and 606 each have the performance rating 516 while the time segment 604 has the performance rating 518. Since the performance rating 516 has the most frequency among the time segments 602-604, the performance drift calculating computing device 102 will determine that the quarterly segment 608 has the performance rating 516. Regarding the score for the quarterly segment, in an embodiment, the performance drift calculating computing device 102 looks at the scores of the time segments that have the performance rating appearing with the most frequency and selects the score with the highest value. For example, the performance rating 516 was selected. As may be seen with reference to FIG. 6, the score 610 of the time segment 602 has a value of 1.8 and the score 614 of the time segment 606 has a value of 2.0. Therefore, the performance drift calculating computing device 102 selects 2.0 as the value for the score 616 of the quarterly segment 608. The same process is repeated for determining the scores 624 and 626 along with the performance ratings 514 and 520 of the quarterly segments 618 and 620.

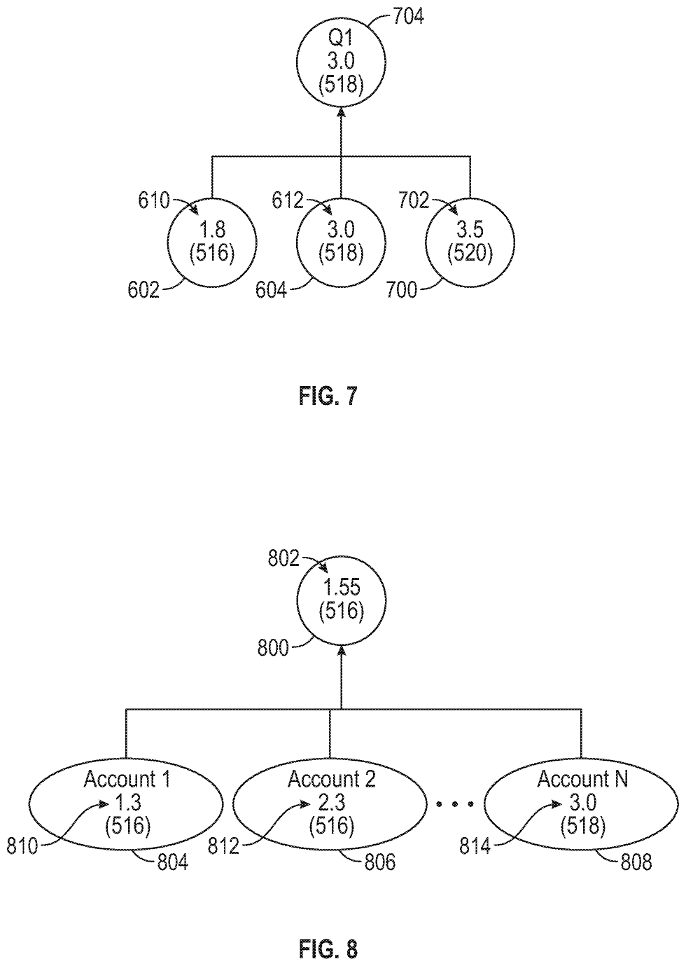

Alternatively, in an embodiment where the time segments all have different performances ratings such that one performance value does not appear with the most frequency, the performance drift calculating computing device 102 selects the mid-range performance rating of the time segments along with the score associated with the mid-range performance rating. To further illustrate, reference is made to FIG. 7, which illustrates the time segments 602 and 604 along with a time segment 700 having a score 702. In this illustration, each of the time segments 602, 604, and 700 have different performance ratings. More specifically, the time segment 602 can include the performance rating 516, the time segment 604 can include the performance rating 518, and the time segment 700 can include the performance rating 520. As shown in the performance rating profile 500, the performance rating 518 is the mid-range performance rating. As such, the performance drift calculating computing device 102 selects the performance rating 518 and the score 612 as the respective performance rating and score of a quarterly segment 704.

Returning attention to FIG. 6, the performance ratings 514, 516, and 520 and the scores 616, 624, and 626 are used to determine a score 630 of the assigned time period 632. In an embodiment, the assigned time period corresponds with the time period determined in the operation 202. Similar to determining the performance rating 516 and the score 616 of the quarterly segment 608, the performance drift calculating computing device 102 determines which performance rating among the performance ratings of the quarterly segments 608, 618, and 620 appears with the most frequency among the quarterly segments forming the assigned time period segment. To further illustrate, as shown with reference to FIG. 6, the quarterly segment 608 has the performance rating 516 while the quarterly segment 618 has the performance rating 520 and the quarterly segment 620 has the performance rating 514. Since the performance ratings do not have a most frequency 516 is the mid-range among the quarterly segments 608, 618 and 620, the performance drift calculating computing device 102 will determine that the assigned time period segment 632 has the performance rating 516.

Regarding the score for the assigned time period segment 632, in an embodiment, the performance drift calculating computing device 102 looks at the scores of the quarterly segments and since there is not a performance rating with the most frequency, the computing device 102 looks at the mid-range performance rating to assign score 630. In an embodiment, the assigned time period corresponds to a time period within which a financial advisor manages a portfolio and, as noted above, the performance rating correlates a drift between the return of the portfolio managed by the financial advisor and the benchmark based on the four factor verification method. In this example, the financial advisor has a performance rating of 516, which in an embodiment, corresponds to a Level 2 Reasonable Performance rating.

In FIG. 6, the assigned time period was one year defined by quarterly segments 608, 618, and 620 where the quarterly segments 608, 618, and 620 were defined by time segments, such as the time segments 602-606 for the quarterly segment 608. In an embodiment where the assigned time period is three years, an assigned time period segment may be defined by three quarterly segments where each of the three quarterly segments are defined by three thirty-six month time segments. In addition, performance ratings and the scores for the assigned time period segment and the quarterly segments in the three year embodiment are determined as discussed above with reference to FIGS. 6 and 7.

According to alternative embodiments, a time segment 800 having a score 802 may be formed by performing the method 200 for a number portfolios managed by the financial advisor. In particular, the financial advisor can be managing accounts (portfolios) 1-N where time segments 804-808 are calculated using the method 200 for each of the accounts I-N, as shown with reference to FIG. 8. In this embodiment, the time segment 804 can include a score 810, the time segment 806 can include a score 812, and the time segment 808 can include a score 814. In this embodiment, the approach to determining a score such as 810 for each of the time segments such as 804 requires the calculation previously described to determine a four factor validation weighted metric score for all N accounts (portfolios) the financial advisor manages. Once all N accounts (portfolios) scores are determined, then next step takes the assets under management (AUM) for each of the accounts relative to the aggregate AUM for all N accounts to generate an AUM weight of account 1 and multiply account 1 time segment performance score by the AUM weight of account 1. This operation is repeated for all N accounts and then the AUM weighted score is summed together to determine the overall score for the particular time segment. This operation is then repeated for the other time segments. The result of the AUM weighted time segments score is determined as 802 and assigned a performance rating profile of 516. 802 based on weighted average of 804, 806, and 808, which can be calculated according to the below:

$$Current Month Profile Time Segment ( 800 ) Score ( 802 ) for Multiple Portfolios = ( Time segment 1 ( 804 ) Performance Score Account 1 ( 810 ) ) * ( Account 1 AUM weight ) + ( Time segment 1 ( 806 ) Performance Score Account 2 ( 812 ) ) * ( Account 2 AUM weight ) + … ( Time segment 1 ( 808 ) Performance Score Account N ( 814 ) ) * ( Account N AUM weight )$$

In an embodiment, once the time segment performance score is determined for multiple portfolios managed by a single financial advisor, the remaining steps follow the same operations as 200, 300, 400, 500, 600, 700 described herein.

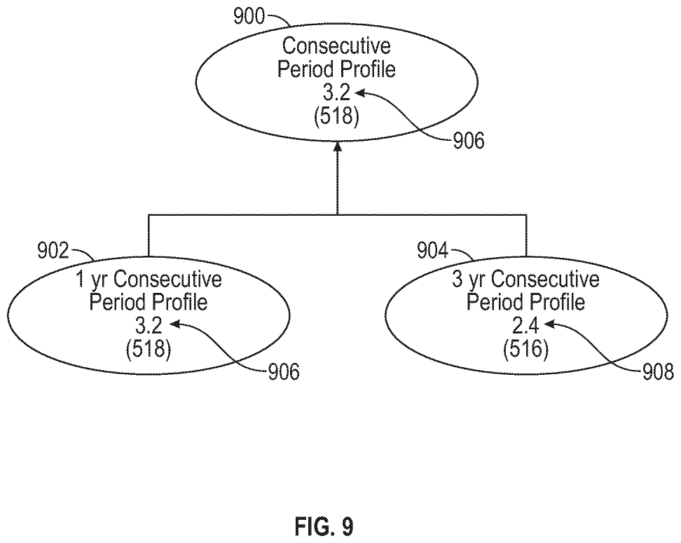

Furthermore, in alternative embodiments, when performance parameters are determined for consecutive time periods, such as performing the methods disclosed herein for a one year period and then performing the methods disclosed herein for a consecutive three year period, the performance ratings for the consecutive time periods may be used to assign a performance rating and hence a drift to a portfolio managed by a financial advisor in comparison to a benchmark for each of the consecutive time periods as a single performance rating. An example of this embodiment is shown with reference to FIG. 9, where an assigned time segment is formed from assigned time segments 902 and 904. In this embodiment, the assigned time segment 902 is for a consecutive one year period and can include a score 906 along with a performance rating 518. Moreover, the assigned time segment 904 is for a consecutive three year period and can include a score 908 along with a performance rating 516. In this embodiment, the performance drift calculating computing device 102 selects the highest risk performance rating along with the score associated with the highest risk performance rating and assigns these values to the assigned time segment 900. To further illustrate, the assigned time segment has a performance rating 518, which is higher risk than the performance rating 516 of the assigned time segment 904. Therefore, the performance drift calculating computing device 102 assigns the score 906 and the performance rating 518 to the assigned time segment 900 in an embodiment. IF both of the 902 and 904 have the same performance rating, that performance rating is assigned to 900 and the highest performance score of 902 and 904 is assigned to 900.

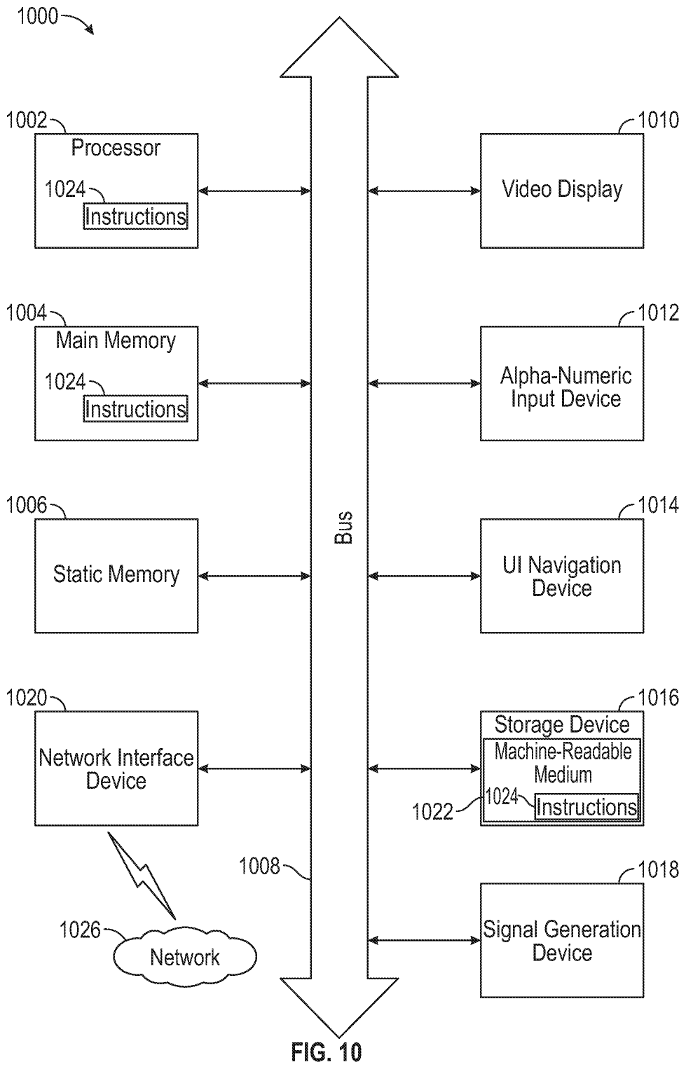

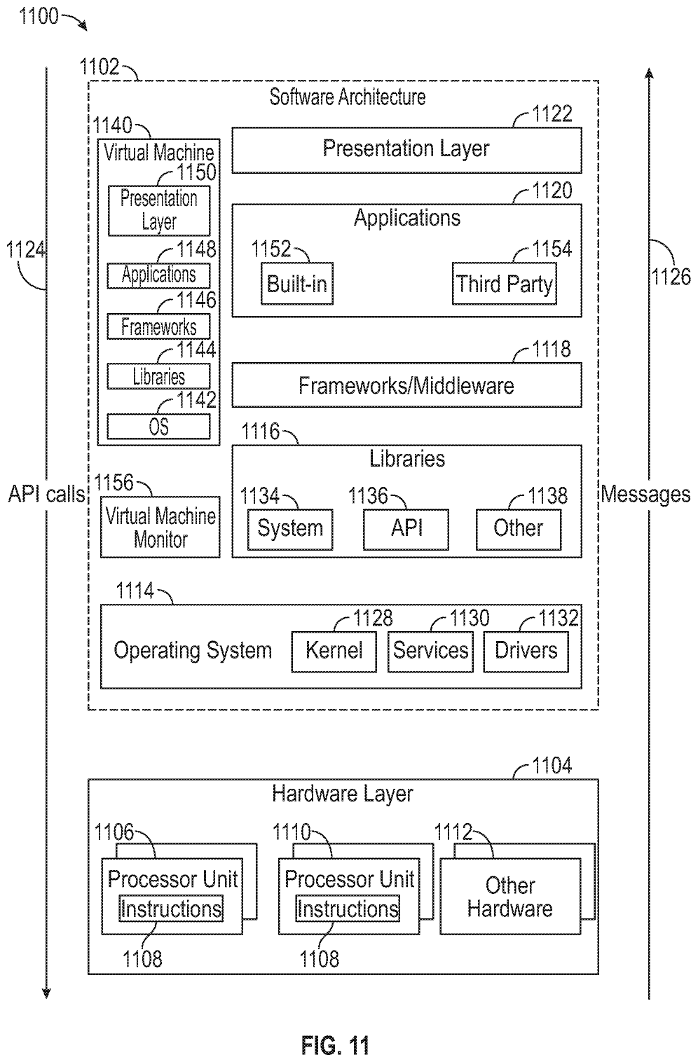

FIG. 10 is a block diagram illustrating the computing device hardware architecture 1000, within which a set or sequence of instructions can be executed to cause the machine to perform examples of any one of the methodologies discussed herein and may be implemented within the performance drift calculating computing device 102. For example, the architecture 1000 may execute software architecture 1102 (FIG. 11). The architecture 1000 may operate as a standalone device or may be connected (e.g., networked) to other machines. In a networked deployment, the architecture 1000 may operate in the capacity of either a server or a client machine in server-client network environments, or it may act as a peer machine in peer-to-peer (or distributed) network environments. The architecture 1000 can be implemented in a personal computer (PC), a tablet PC, a hybrid tablet, a set-top box (STB), a personal digital assistant (PDA), a mobile telephone, a web appliance, a network router, switch or bridge, or any machine capable of executing instructions (sequential or otherwise) that specify operations to be taken by that machine.

Example architecture 1000 includes a processor unit 1002 comprising at least one processor (e.g., a central processing unit (CPU), a graphics processing unit (GPU) or both, processor cores, compute nodes, etc.). The architecture 1000 may further comprise a main memory 1004 and a static memory 1006, which communicate with each other via a link 1008 (e.g., bus). The architecture 1000 can further include a video display unit 1010, an alphanumeric input device 1012 (e.g., a keyboard), and a user interface (UI) navigation device 1014 (e.g., a mouse). In some examples, the video display unit 1010, input device 1012 and UI navigation device 1014 are incorporated into a touch screen display. The architecture 1000 may additionally include a storage device 1016 (e.g., a drive unit), a signal generation device 1018 (e.g., a speaker), a network interface device 1020, and one or more sensors (not shown), such as a global positioning system (GPS) sensor, compass, accelerometer, or other sensor.

In some examples, the processor unit 1002 or other suitable hardware component may support a hardware interrupt. In response to a hardware interrupt, the processor unit 1002 may pause its processing and execute an interrupt service routine (ISR), for example, as described herein.

The storage device 1016 includes a machine-readable medium 1022 on which is stored one or more sets of data structures and instructions 1024 (e.g., software) embodying or utilized by any one or more of the methodologies or functions described herein. For example, the benchmark drift performance profile 400 may be stored on the storage device 1016 such that the benchmark drift performance profile 400 is stored on the performance drift calculating computing device 102. The instructions 1024 can also reside, completely or at least partially, within the main memory 1004, static memory 1006, and/or within the processor unit 1002 during execution thereof by the architecture 1000, with the main memory 1004, static memory 1006, and the processor unit 1002 also constituting machine-readable media. Instructions 1024 stored at the machine-readable medium 1022 may include, for example, instructions for implementing the software architecture 1102, instructions for executing any of the features described herein, etc.

While the machine-readable medium 1022 is illustrated in an example to be a single medium, the term “machine-readable medium” can include a single medium or multiple media (e.g., a centralized or distributed database, and/or associated caches and servers) that store the one or more instructions 1024. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including, but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 1024 can further be transmitted or received over a communications network 1026 using a transmission medium via the network interface device 1020 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Wi-Fi, 3G, and 6G LTE/LTE-A or WiMAX networks). The term “transmission medium” shall be taken to include any intangible medium that is capable of storing, encoding, or carrying instructions (e.g., instructions 1024) for execution by the machine, and includes digital or analog communications signals or other intangible medium to facilitate communication of such software.

FIG. 11 is a block diagram 1100 showing one example of the software architecture 1102 for a computing device. The architecture 1102 can be used in conjunction with various hardware architectures, for example, as described herein. FIG. 11 is merely a non-limiting example of a software architecture 1102 and many other architectures may be implemented to facilitate the functionality described herein. The software architecture 1102 may be executed on hardware such as, for example, any of the systems or subsystems described herein. A representative hardware layer 1104 is illustrated and can represent, for example, any of the above referenced computing devices. In some examples, the hardware layer 1104 may be implemented according to the architecture 1102 of FIG. 11 and/or the architecture 1000 of FIG. 10.

The representative hardware layer 1104 comprises one or more processing units 1106 having associated executable instructions 1108. Executable instructions 1108 represent the executable instructions of the software architecture 1102, including implementation of the methods, systems, components, and so forth of FIGS. 1-9. Hardware layer 1104 also includes memory and/or storage modules 1110, which also have executable instructions 1108. Hardware layer 1104 may also comprise other hardware as indicated by other hardware 1112 which represents any other hardware of the hardware layer 1104, such as the other hardware illustrated as part of hardware architecture 1000.

In the example architecture of FIG. 11, the software architecture 1102 may be conceptualized as a stack of layers where each layer provides particular functionality. For example, the software architecture 1102 may include layers such as an operating system 1114, libraries 1116, frameworks/middleware 1118, applications 1120 and a presentation layer 1122. Operationally, the applications 1120 and/or other components within the layers may invoke application programming interface (API) calls 1124 through the software stack and receive a response, returned values, and so forth illustrated as messages 1126 in response to the API calls 1124. The layers illustrated are representative in nature and not all software architectures have all layers. For example, some mobile or special purpose operating systems may not provide a frameworks/middleware layer 1118, while others may provide such a layer. Other software architectures may include additional or different layers.

The operating system 1114 may manage hardware resources and provide common services. The operating system 1114 may include, for example, a kernel 1128, services 1130, and drivers 1132. The kernel 1128 may act as an abstraction layer between the hardware and the other software layers. For example, the kernel 1128 may be responsible for memory management, processor management (e.g., scheduling), component management, networking, security settings, and so on. The services 1130 may provide other common services for the other software layers. In some examples, the services 1130 include an interrupt service. The interrupt service may detect the receipt of a hardware or software interrupt and, in response, cause the architecture 1102 to pause its current processing and execute an interrupt service routine (ISR) when an interrupt is received. The ISR may generate the alert, for example, as described herein.

The drivers 1132 may be responsible for controlling or interfacing with the underlying hardware. For instance, the drivers 1132 may include display drivers, camera drivers, Bluetooth® drivers, flash memory drivers, serial communication drivers (e.g., Universal Serial Bus (USB) drivers), Wi-Fi® drivers, NFC drivers, audio drivers, power management drivers, and so forth depending on the hardware configuration.

The libraries 1116 may provide a common infrastructure that may be utilized by the applications 1120 and/or other components and/or layers. The libraries 1116 typically provide functionality that allows other software modules to perform tasks in an easier fashion than to interface directly with the underlying operating system 1114 functionality (e.g., kernel 1128, services 1130 and/or drivers 1132). The libraries 1116 may include system libraries 1134 (e.g., C standard library) that may provide functions such as memory allocation functions, string manipulation functions, mathematic functions, and the like. In addition, the libraries 1116 may include API libraries 1136 such as media libraries (e.g., libraries to support presentation and manipulation of various media format such as MPEG4, H.1024, MP3, AAC, AMR, JPG, PNG), graphics libraries (e.g., an OpenGL framework that may be used to render 2D and 9D in a graphic content on a display), database libraries (e.g., SQLite that may provide various relational database functions), web libraries (e.g., WebKit that may provide web browsing functionality), and the like. The libraries 1116 may also include a wide variety of other libraries 1138 to provide many other APIs to the applications 1120 and other software components/modules.

The frameworks 1118 (also sometimes referred to as middleware) may provide a higher-level common infrastructure that may be utilized by the applications 1120 and/or other software components/modules. For example, the frameworks 1118 may provide various graphic user interface (GUI) functions, high-level resource management, high-level location services, and so forth. The frameworks 1118 may provide a broad spectrum of other APIs that may be utilized by the applications 1120 and/or other software components/modules, some of which may be specific to a particular operating system or platform.

The applications 1120 include built-in applications 1152 and/or third-party applications 1154. Examples of representative built-in applications 1152 may include, but are not limited to, a contacts application, a browser application, a book reader application, a location application, a media application, a messaging application, and/or a game application. Third-party applications 1154 may include any of the built-in applications 1152 as well as a broad assortment of other applications. In a specific example, the third-party application 1154 (e.g., an application developed using the Android™ or iOS™ software development kit (SDK) by an entity other than the vendor of the particular platform) may be mobile software running on a mobile operating system such as iOS™, Android™, Windows® Phone, or other mobile computing device operating systems. In this example, the third-party application 1154 may invoke the API calls 1124 provided by the mobile operating system such as operating system 1114 to facilitate functionality described herein.

The applications 1120 may utilize built-in operating system functions (e.g., kernel 1128, services 1130 and/or drivers 1132), libraries (e.g., system libraries 1134, PI libraries 1136, and other libraries 1138), frameworks/middleware 1118 to create user interfaces to interact with users of the system. Alternatively, or additionally, in some systems, interactions with a user may occur through a presentation layer, such as presentation layer 1122. In these systems, the application/module “logic” can be separated from the aspects of the application/module that interact with a user.

Some software architectures utilize virtual machines. For example, systems described herein may be executed utilizing one or more virtual machines executed at one or more server computing machines. In the example of FIG. 11, this is illustrated by virtual machine 1140. A virtual machine creates a software environment where applications/modules can execute as if they were executing on a hardware computing device. A virtual machine 1140 is hosted by a host operating system (operating system 1114) and typically, although not always, has a virtual machine monitor 1156, which manages the operation of the virtual machine 1140 as well as the interface with the host operating system (i.e., operating system 1114). A software architecture executes within the virtual machine 1140 such as an operating system 1142, libraries 1144, frameworks/middleware 1146, applications 1148 and/or presentation layer 1150. These layers of software architecture executing within the virtual machine 1140 can be the same as corresponding layers previously described or may be different.

Various components are described in the present disclosure as being configured in a particular way. A component may be configured in any suitable manner. For example, a component that is or that includes a computing device may be configured with suitable software instructions that program the computing device. A component may also be configured by virtue of its hardware arrangement or in any other suitable manner.

The above description is intended to be illustrative, and not restrictive. For example, the above-described examples (or one or more aspects thereof) can be used in combination with others. Other embodiments can be used, such as by one of ordinary skill in the art upon reviewing the above description. The Abstract is to allow the reader to quickly ascertain the nature of the technical disclosure, for example, to comply with 37 C.F.R. § 1.72(b) in the United States of America. It is submitted with the understanding that it will not be used to interpret or limit the scope or meaning of the claims.

Also, in the above Detailed Description, various features can be grouped together to streamline the disclosure. However, the claims cannot set forth every feature disclosed herein as embodiments can feature a subset of said features. Further, embodiments can include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

What is claimed is:

1. A method of determining performance drift using a computing device with a processing unit, the method comprising:
assigning, using the processing unit, a first time period for which a first performance drift should be calculated, the first time period having a plurality of sub-first time periods each extending over the first time period;
selecting, using the processing unit, a first category for which a first metric for the first performance drift is to be calculated;
calculating, using the processing unit, the first metric;
establishing a first communication session over a network with a database;
retrieving, using the processing unit, a performance rating profile from the database via the first communication session;
comparing, using the processing unit, the first metric to the performance rating profile;
assigning, using the processing unit, a first score to the first metric based on the comparison between the first metric and the performance rating profile, wherein the performance rating profile includes a plurality of value ranges and comparing the first metric to the performance rating profile includes comparing the first metric to the plurality of value ranges and assigning the first score to the first metric is based on the comparison of the first metric to the plurality of value ranges where the first metric falls within a value range of the plurality of value ranges;
determining, using the processing unit, that a second metric for a second category is required for the first performance drift to be calculated;
repeating, using the processing unit, the calculating, the comparing, and the assigning operations for the second metric, wherein the processing unit assigns a second score for the second metric;
determining, using the processing unit, the first performance drift for the first time period based on the first score for the first metric and the second score for the second metric, wherein a first multifactor verification is used for each sub-first time period extending over the first time period of the plurality of sub-first time periods to determine the first performance drift, the first multifactor verification including a plurality of verifications selected from a relative sharpe ratio, an upside capture ratio, a downside capture ratio, a tracking error metric, and a relative value-at-risk metric;
assigning, using the processing unit, a second time period for which a second performance drift should be calculated, the second time period having a plurality of sub-second time periods each extending over the second time period;
repeating, using the processing unit, the calculating, the comparing, and the assigning operations for first and second metrics for the second time period;
determining, using the processing unit, the second performance drift for the second time period based on a first score for the second time period first metric and a second score f_r the second time period second metric, wherein a second multifactor verification is used for each sub-second time period extending over the second time period of the plurality of sub-second time periods to determine the second performance drift, the second multifactor verification including a plurality of verifications selected from a relative sharpe ratio, an upside capture ratio, a downside capture ratio, a tracking error metric, and a relative value-at-risk metric, where the performance drift is selected from one of the first performance drift and the second performance drift; and
establishing a second communication session over a network with a user device to display information on the user device.

2-3. (canceled)

4. The method as recited in claim 1, wherein the first performance drift has a first value and the second performance drift has a second value, the method further comprising:
comparing, using the processing unit, the first value and the second value; and
determining, using the processing unit, the performance drift for the time period based on comparing the first value and the second value.

5. The method as recited in claim 1, the method further comprising:
determining, using the processing unit, that a third metric for a third category is required for the performance drift to be calculated; and
repeating, using the processing unit, the calculating, the comparing, and the assigning operations for the third metric, wherein the processing unit assigns a third score for the third metric.

6. The method as recited in claim 1, wherein determining the performance drift for the time period comprises:
weighting, using the processing unit, each of the first score and the second score;
combining, using the processing unit, the first score and the second score to form a combined score; and
comparing the combined score with a performance rating profile in order to determine a risk level of the performance drift for the time period.

7. The method as recited in claim 1, the method further comprising:
generating, using the processing unit, time segments, wherein determining the performance drift for the time period further comprises determining the performance drift for each of the time segments;
after determining the performance drift for a time segment of the time segments, determining if an additional time segment requires the calculation of an additional performance drift; and
repeating, using the processing unit, the calculating, the comparing, and the assigning operations for a third metric associated with a third category for the additional time segment, wherein the processing unit assigns a third score for the third metric.

8. A non-transitory, machine-readable medium, comprising instructions, which when performed by a processing unit of a computing device, causes the processing unit to perform operations to:
assign a first time period for which a first performance drift should be calculated, the first time period having a plurality of sub-first time periods each extending over the first time period;
select a first category for which a first metric for the first performance drift is to be calculated;
calculate the first metric;
establish a first communication session over a network with a database;
retrieve a performance rating profile from the database via the first communication session;
compare the first metric to the performance rating profile;
assign a first score to the first metric based on the comparison between the first metric and the performance rating profile, wherein the performance rating profile includes a plurality of value ranges and comparing the first metric to the performance rating profile includes comparing the first metric to the plurality of value ranges and assigning the first score to the first metric is based on the comparison of the first metric to the plurality of value ranges where the first metric falls within a value range of the plurality of value ranges;
determine that a second metric for a second category is required for the first performance drift to be calculated;
repeat the calculating, the comparing, and the assigning operations for the second metric, wherein the processing unit assigns a second score for the second metric;
determine the first performance drift for the first time period based on the first score for the first metric and the second score for the second metric, wherein a first multifactor verification is used for each sub-first time period extending over the first time period of the plurality of sub-first time periods to determine the first performance drift, the first multifactor verification including a plurality of verifications selected from a relative sharpe ratio, an upside capture ratio, a downside capture ratio, a tracking error metric, and a relative value-at-risk metric;
assign a second time period for which a second performance drift should be calculated, the second time period having a plurality of sub-second time periods each extending over the second time period;
repeat the calculating, the comparing, and the assigning operations for first and second metrics for the second time period;
determine the second performance drift for the second time period based on a first score for the second time period first metric and a second score for the second time period second metric, wherein a second multifactor verification is used for each sub-second time period extending over the second time period of the plurality of sub-second time periods to determine the second performance drift, the second multifactor verification including a plurality of verifications selected from a relative sharpe ratio, an upside capture ratio, a downside capture ratio, a tracking error metric, and a relative value-at-risk metric, where the performance drift is selected from one of the first performance drift and the second performance drift; and
establish a second communication session over a network with a user device to display information on the user device.

9-10. (canceled)

11. The medium as recited in claim 8, wherein the first performance drift has a first value and the second performance drift has a second value and the instructions further cause the processing unit to perform operations to:
compare the first value and the second value; and
determine the performance drift for the time period based on comparing the first value and the second value.

12. The medium as recited in claim 8, wherein the instructions further cause the processing unit to perform operations to:
determine that a third metric for a third category is required for the performance drift to be calculated; and
repeat the calculating, the comparing, and the assigning operations for the third metric, wherein the processing unit assigns a third score for the third metric.

13. The medium as recited in claim 8, wherein determining the performance drift for the time period comprises:
weighting, using the processing unit, each of the first score and the second score;
combining, using the processing unit, the first score and the second score to form a combined score; and
comparing the combined score with a performance rating profile in order to determine the performance drift for the time period.

14. The medium as recited in claim 8, wherein the instructions further cause the processing unit to perform operations to:
generate time segments, wherein determining the performance drift for the time period further comprises determining the performance drift for each of the time segments;
after determining the performance drift for a time segment of the time segments, determine if an additional time segment requires the calculation of an additional performance drift; and
repeat the calculating, the comparing, and the assigning operations for a third metric associated with a third category for the additional time segment, wherein the processing unit assigns a third score for the third metric.

15. A system comprising:
processing circuitry; and
a memory device including instructions embodied thereon, wherein the instructions, which when executed by the processing circuitry, configure the processing circuitry to perform operations comprising:
assigning a first time period for which a first performance drift should be calculated, the first time period having a plurality of sub-first time periods each extending over the first time period;
selecting a first category for which a first metric for the first performance drift is to be calculated;
calculating the first metric;
establishing a first communication session over a network with a database;
retrieving a performance rating profile from the database via the first communication session;
comparing the first metric to the performance rating profile;
assigning a first score to the first metric based on the comparison between the first metric and the performance rating profile, wherein the performance rating profile includes a plurality of value ranges and comparing the first metric to the performance rating profile includes comparing the first metric to the plurality of value ranges and assigning the first score to the first metric is based on the comparison of the first metric to the plurality of value ranges where the first metric falls within a value range of the plurality of value ranges; determining that a second metric for a second category is required for the first performance drift to be calculated;
repeating the calculating, the comparing, and the assigning operations for the second metric, wherein the processing circuitry assigns a second score for the second metric; determining the first performance drift for the first time period based on the first score for the first metric and the second score for the second metric, wherein a first multifactor verification is used for each sub-first time period extending over the first time period of the plurality of sub-first time periods to determine the first performance drift, the first multifactor verification including a plurality of verifications selected from a relative sharpe ratio, an upside capture ratio, a downside capture ratio, a tracking error metric, and a relative value-at-risk metric;
assigning a second time period for which a second performance drift should be calculated, the second time period having a plurality of sub-second time periods each extending over the second time period;
repeating the comparing, and the assigning operations for first and second metrics for the second time period;
determining the second performance drift for the second time period based on a first score for the second time period first metric and a second score for the second time period second metric, wherein a second multifactor verification is used for each sub-second time period extending over the second time period of the plurality of sub-second time periods to determine the second performance drift, the second multifactor verification including a plurality of verifications selected from a relative sharpe ratio, an upside capture ratio, a downside capture ratio, a tracking error metric, and a relative value-at-risk metric, where the performance drift is selected from one of the first performance drift and the second performance drift; and
establishing a second communication session over a network with a user device to display information on the user device.

16-17. (canceled)

18. The system as recited in claim 15, wherein the first performance drift has a first value and the second performance drift has a second value, wherein the instructions further configure the processing circuitry to perform operations comprising:
comparing the first value and the second value; and
determining the performance drift for the time period based on comparing the first value and the second value.

19. The system as recited in claim 15, wherein the instructions further configure the processing circuitry to perform operations comprising:
determining that a third metric for a third category is required for the performance drift to be calculated; and
repeating the calculating, the comparing, and the assigning operations for the third metric, wherein the processing circuitry assigns a third score for the third metric.

20. The system as recited in claim 15, wherein determining the performance drift for the time period comprises:
weighting each of the first score and the second score;
combining the first score and the second score to form a combined score; and
comparing the combined score with a performance rating profile in order to determine the performance drift for the time period.

21. The system as recited in claim 15, wherein the instructions further configure the processing circuitry to perform operations comprising:
generating time segments, wherein determining the performance drift for the time period further comprises determining the performance drift for each of the time segments;
after determining the performance drift for a time segment of the time segments, determining if an additional time segment requires the calculation of an additional performance drift; and
repeating the calculating, the comparing, and the assigning operations for a third metric associated with a third category for the additional time segment, wherein the processing circuitry assigns a third score for the third metric.
